(19) United States
(12) Patent Application Publication
(10) Pub. No.: US 2008/0257956 A1
(43) Pub. Date: Oct. 23, 2008

(54) SYSTEM FOR FULFILLING PURCHASES

(75) Inventors: MICHAEL GRANNAN, AUSTIN, TX (US); LALITHA SURYANARAYANA, AUSTIN, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/737,656

(22) Filed: Apr. 19, 2007

(51) Int. Cl. G06K 19/00

(52) U.S. Cl. 235/380

(57) ABSTRACT

A purchase key is disclosed. A system that incorporates teachings of the present disclosure may include, for example, a purchase fulfillment device can have a storage medium to store a plurality of purchase fulfillment identifiers (IDs) issued by a corresponding plurality of credit providers, and a biometric reader to enable access to a point of sale (POS) device to retrieve at least one among the plurality of purchase fulfillment IDs in the storage medium. Additional embodiments are disclosed.

### FIELD OF THE DISCLOSURE

The present disclosure relates generally to communication devices, and more specifically to an improved system for fulfilling purchases.

### BACKGROUND

As a form of payment, a user can present a credit or debit card to a point of sale (POS) device such as a common credit card reader to fulfill a purchase of a good or service. Utilizing common techniques, a POS device submits the amount due to the credit or debit card issuer requesting approval for payment. If given, the user may be asked to also provide a signature to complete the transaction. Many consumers carry more than one credit or debit card, and identification information in case they are asked by a merchant for such information to secure the payment.

Although this payment method is convenient, consumers sometimes inadvertently misplace, lose or are victims of a stolen wallet or purse carrying credit cards and their identification cards. When this happens, consumers often call their credit card companies and bank to restrict usage of these cards. If consumers call after the cards have been used without authorization, the consumer usually undertakes a lengthy process to limit further liability such as by placing a fraud alert with credit bureaus, and signing affidavits with their credit card companies to affirm that the purchases made were not authorized. This can be a very frustrating and time consuming experience for anyone who uses these payment methods.

A need therefore arises for an improved system for fulfilling purchases.

### BRIEF DESCRIPTION OF THE DRAWINGS

FIG. 1 depicts an exemplary embodiment of a purchase fulfillment device;

FIG. 2 depicts an exemplary embodiment of the purchase fulfillment device operatively coupled to a Point of Sale (POS) device or another computing device;

FIG. 3 depicts an exemplary method for conducting a purchase transaction with the purchase fulfillment device;

FIG. 4 illustrates an exemplary graphical user interface presented in response to engaging a transaction between the purchase fulfillment device and the POS device;

FIG. 5 illustrates an exemplary web page for conducting on-line transactions with the purchase fulfillment device;

FIGS. 6-7 depict exemplary methods for provisioning the purchase fulfillment device; and

FIG. 8 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide an improved system for fulfilling purchases.

In a first embodiment of the present disclosure, a purchase fulfillment device can have a storage medium to store a plurality of purchase fulfillment identifiers (IDs) issued by a corresponding plurality of credit providers, and a biometric reader to enable access to a point of sale (POS) device to retrieve at least one among the plurality of purchase fulfillment IDs in the storage medium.

In a second embodiment of the present disclosure, a POS device can have a controller element to receive from a purchase fulfillment device at least one among a plurality of purchase fulfillment IDs to process a transaction associated with a purchase of a good or service responsive to a biometric authentication validated by the purchase fulfillment device.

In a third embodiment of the present disclosure, a transaction server can have a controller element to receive at least one among a plurality of purchase fulfillment IDs retrieved by a point of sale (POS) device from a memory of a purchase fulfillment device in response to a biometric authorization validated by the purchase fulfillment device.

In a fourth embodiment of the present disclosure, a processing system can have a controller element to provision a storage medium of a purchase fulfillment device with a plurality of purchase fulfillment IDs, wherein access to the plurality of purchase fulfillment IDs stored in the storage medium is secured by a biometric reader.

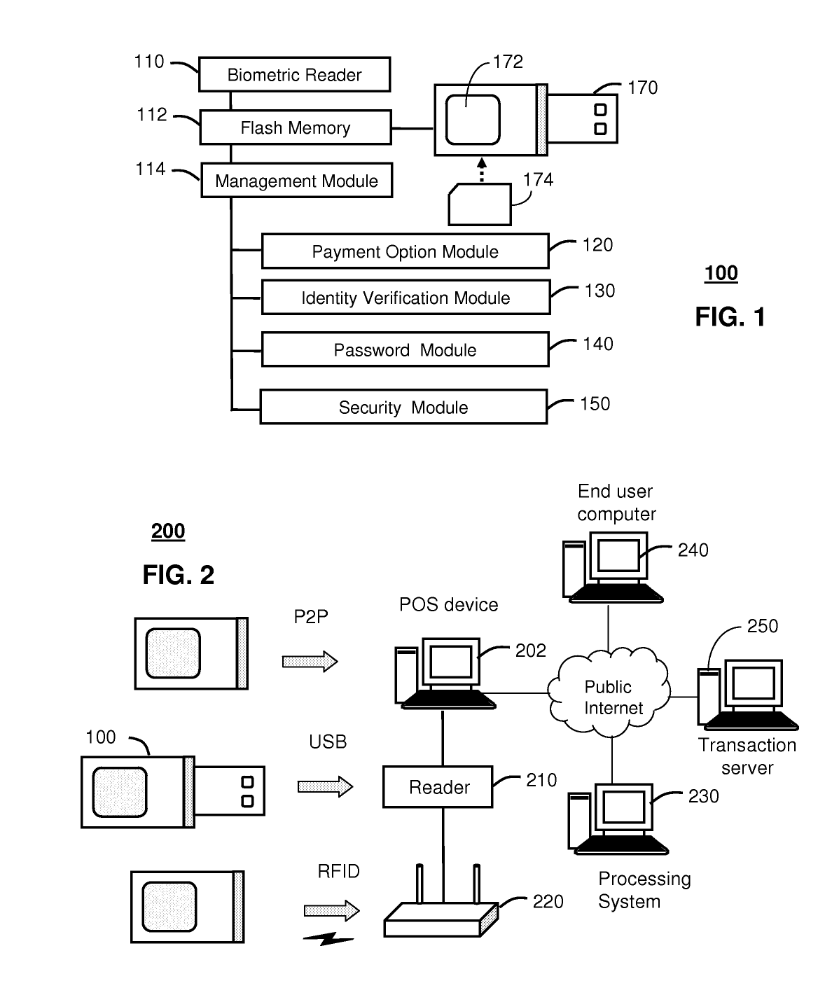

FIG. 1 depicts a purchase fulfillment device 100 for managing and authorizing multiple forms of electronic transactions. The purchase fulfillment device 100 can include a biometric reader 110, a memory 112, and a management module 114. As an example, the memory 112 can be a flash memory housed in any number of common form factors such as a micro Secure Device (microSD), multi-media card (MMC), or a reduced size multi-media card (RS-MMC). The memory 112 can also be integrated in an identity module such as a Subscriber Identity Module (SIM) card or a Removable User Identification Module (RUIM) card. In this embodiment, the SIM or RUIM card can be slideably coupled to the purchase fulfillment device 100 by way of a slot in its housing, or inserted into a compartment that carries such cards accessible on one of the sides of the purchase fulfillment device 100.

The memory 112 can be used store a plurality of purchase fulfillment identifiers (IDs) associated with one or more biometric identifiers. The plurality of purchase fulfillment IDs can include credit card numbers, account numbers, passwords, log-in credentials, identity information, age information, and other identifiers.

The biometric reader 110 can utilize common technologies to capture a biometric identifier, such as a fingerprint, a retinal scan, or voice print. Briefly, the biometric reader 110 can enable access to the plurality of purchase fulfillment IDs in the memory 112 in response to a biometric authentication. As an example, the purchase fulfillment device 100 can authenticate a user's fingerprint by way of a user coupling or sliding a finger on an exposed surface of the biometric reader 110, thereby enabling access to the memory 112 when a valid fingerprint match is detected, and providing at least one of the plurality of purchase fulfillment IDs to a Point of Sales (POS) device to process a purchase transaction.

For illustration purposes only, the purchase fulfillment device 100 will be referred to herein as a purchase key 100.

The management module 114 can include a payment option module 120, an identity verification module 130, a password module 140, and a security module 150. The payment option module 120 can identify various types of payment methods available using the purchase key. In one configuration, the payment option module 120 can be a credit card module that utilizes common technology to organize credit card credentials and maintain account information, such as account number, balance, available credit and interest rate. The payment option module 120 can also be used to manage the exchange of account information with a POS device. The identity verification module 130 can utilize common technology to validate a user's identity and age for merchants' validation for certain types of purchases (e.g., purchasing alcohol, renting a car, etc.).

The identity verification module 130 can also utilize a biometric matching algorithm that verifies an identity of a user based on a biometric signature captured by the biometric reader 110. The password module 140 can utilize common technology to keep track of user names and passwords as well as Internet Log-in names, account names, or websites-just to mention a few. The security module 150 can utilize common security techniques such as encryption to mitigate unauthorized monitoring of communications between the purchase fulfillment device 100 and a POS device.

The purchase fulfillment device 100 can also include a communication interface 170 that provides external devices wired or wireless access to the memory 112. FIG. 2 depicts various embodiments of the purchase key 100 including among them means for fulfilling a purchase transaction with a POS device 202 and means to provision the purchase fulfillment device 100 by way of a general computing device coupled to a processing system 230, or transaction server 250 over a public Internet. In this illustration, the POS device 202 can be an on-premise computer or electronic cash register but is not limited to these. The POS device 202 can be coupled to a transaction server 250, which can serve as a center for credit or debit card transactions or for issuing credit to consumers.

In a first embodiment, the communication interface 170 of the purchase key 100 can provide Universal Serial Bus (USB) to engage with a USB port of the POS device 202. In another arrangement, the POS device 202 can provide a USB extension cable that couples to the purchase fulfillment device 100. In either of these embodiments, the POS device 202 can represent a cash register or a credit card reader 210 having a touch screen display with a USB port that can be coupled to the purchase key 100. In yet another embodiment, the communication interface 170 can support short-range wireless communications. In this embodiment, communications between the purchase key 100 and the POS device 202 can conform to common protocols such as Bluetooth, WiFi, Zigbee, Peer-to-Peer (P2P), cordless phone technology, client/server communications, and communication techniques used by RFIDs. Accordingly, the POS device 202 can utilize common RF communication technology such as an RFID reader 220 to retrieve data from the purchase key 100. In this embodiment, the communication interface 170 combined with the memory 122 can be embodied in a common RFID tag activated when in proximity to the RFID reader 220. Other wireless access technologies can be contemplated for the communication interface 170.

From the foregoing embodiment, it should be evident that the purchase key 100 can serve as a secure storage medium for credit and debit account information, identity and age verification, and any other form of personal data which a user may find useful for engaging in day-to-day transactions. The storage medium is secure in that access to the data can rely on an authentication process, and/or that the purchase key 100 can encrypt the data using common encryption techniques. With a purchase key 100 users can replace all or a portion of their credit cards and/or debit cards generally stored in a wallet or purse. Given its small size, a purchase key 100 can be used as an accessory such as a keychain, or some other suitable form of a carry-on item.

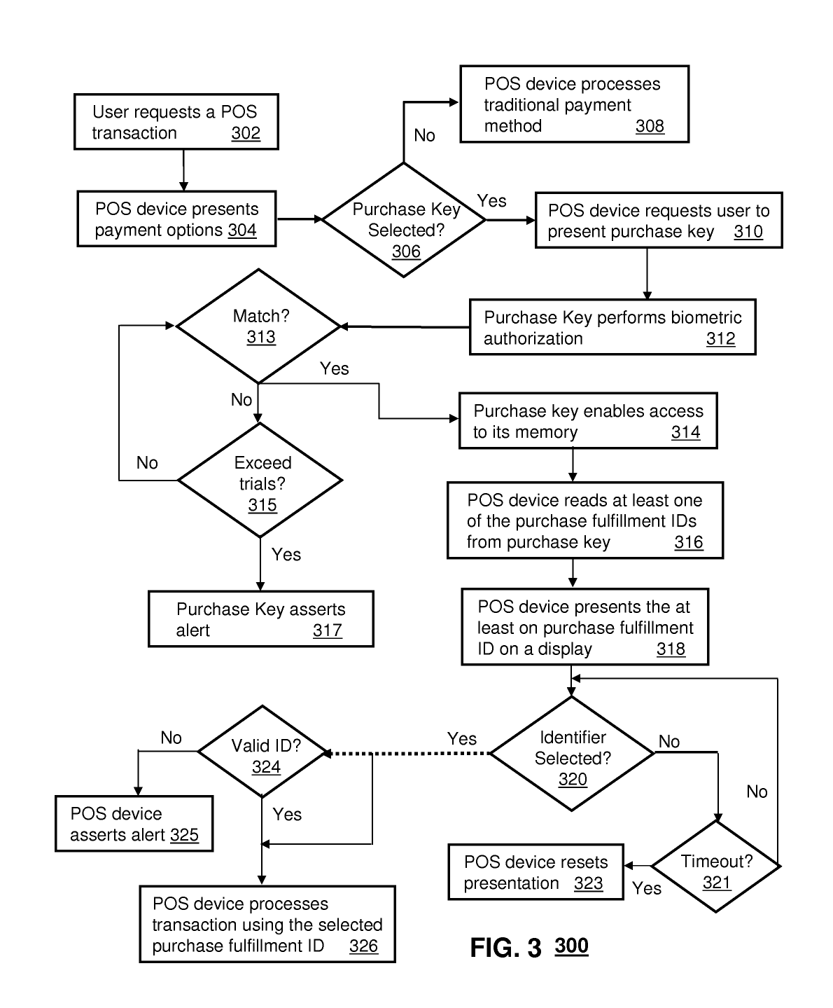

FIG. 3 depicts an exemplary method 300 for conducting a transaction with a purchase key 100. Method 300 can include more or less than the number of steps shown, and is not limited to the order of the steps shown in the flowchart of FIG. 3. Method 300 begins with step 302, wherein a user requests a POS transaction. As one example, a consumer presents a merchant employee a request to purchase a good or service utilizing a POS device 202 such as a cash register and/or credit or debit card reader. At step 304, the POS device 202 presents a consumer payment options. For example, the POS device 202 can present a list of payment options such as a purchase key or various credit or debit card types on a display of the POS device 202. At step 306, the POS device 202 can determine if a purchase key 100 is selected as the form of payment. If the consumer selects a form of payment other than the purchase key 100, the POS device 202 can process the transaction using traditional payment methods at step 308.

If the consumer selects the purchase key 100 payment option, at step 310, the POS device 202 requests that the consumer engage the purchase key 100 by physical or wireless means as previously described. At step 312, the purchase key 100 can perform a biometric authorization to enable access to at least one of the purchase fulfillment IDs stored in memory 112. This can be accomplished by for example the user placing or sliding a finger on slot 172 of the biometric reader 110. The identity verification module 120 can authenticate the user by matching a captured fingerprint and fingerprint information associated with the end user that is pre-stored in the memory 112. If a match is not detected in step 313, the purchase key 100 checks in step 315 whether a number of attempts to access the memory 112 of the purchase key 100 has been exceeded. If it has, the purchase key 100 can be programmed to assert an alert in step 317 that disables normal operations of the purchase key 100. In this state, the purchase key 100 can be re-enabled by extraordinary means such as by presenting a combination of fingerprints of the user. This combination can be a pre-programmed security feature for reinstating normal operations of the purchase key 100.

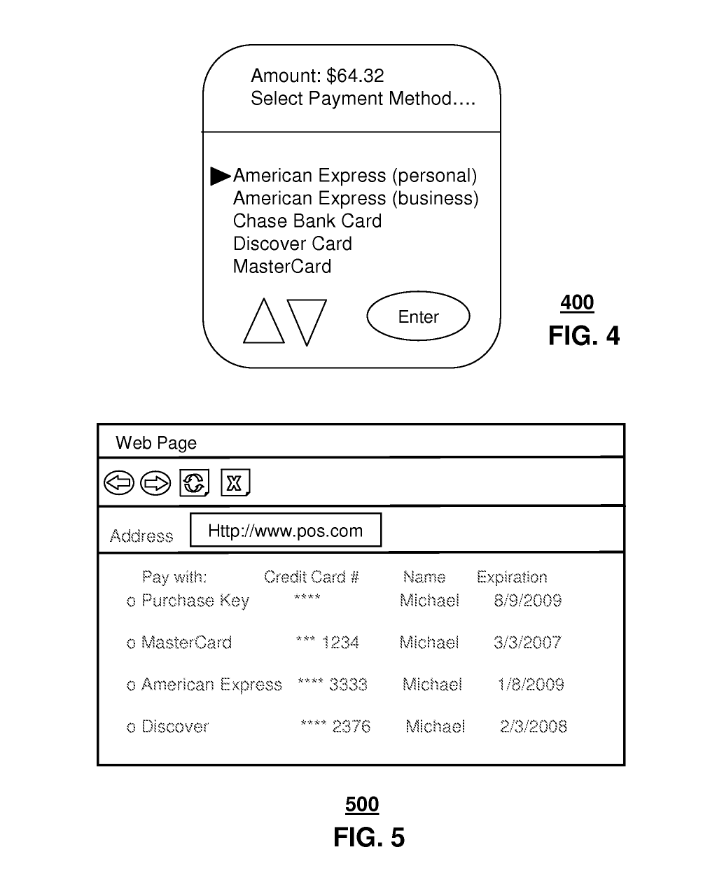

When a fingerprint match is detected in step 313 without exceeding a fixed number of failed attempts, the purchase key 100 enables access to the memory 112 in step 314. At step 316, the POS device 202 retrieves at least one of the purchase fulfillment IDs from the unlocked memory 112. The POS device 202 can be programmed to read all of the payment methods stored on the purchase key 100 in step 318. In this case, the POS device 202 presents a graphical user interface (GUI) with one or more purchase options for the buyer to select which particular credit/debit accounts s/he wishes to use to consummate the purchase requested. For example, referring to FIG. 4, the POS device 202 can present a GUI 400 showing the amount due ($64.32) and one or more selectable purchase options.

Referring back to FIG. 3, at step 320, the POS device 202 can determine whether the user has made a selection of a purchase fulfillment ID for processing the transaction. If a selection is not made, the POS device 202 checks for a timeout period at step 321, and performs a reset operation on the GUI 400 at step 323 if the timeout period is triggered. In this instance, the updated GUI 400 can present an error message or a request for the user to restart the purchase fulfillment process starting from step 310. If on the other hand the POS device 202 detects that the user has selected a purchase fulfillment ID, the POS device 202 processes the transaction using the selected purchase fulfillment ID, at step 326. In this step, the purchase fulfillment ID (e.g., credit provider, credit account number, expiration date, name of account holder, three digit code, etc.) is submitted by the POS device 202 to a transaction server 250 that processes credit or debit transactions for banks by common means used today.

In a supplemental embodiment, at step 324, the POS device 202 can validate an identification and/or an age of the user with credential supplied by the identity verification module 130 prior to processing the purchase transaction in step 326. If the credentials are deemed valid by the POS device 202 or by a common validation system coupled thereto, the POS device 202 presents the merchant the consumer's credentials. If the merchant is satisfied with the credentials, then the merchant directs the POS device 202 to proceed to step 326 to process the transaction as described earlier. Otherwise the POS device 202 proceeds to step 325 where it asserts an alert. The alert can be a silent alert which informs security personnel, or a merchant employee processing the transaction. Alternatively, the alert can present the user an error message indicating that the transaction cannot be successfully completed due to a discrepancy with the credentials provided.

Notably, the purchase key 100, which can be handled and operated by a consumer, incorporates biometric authorization (e.g. fingerprint matching) to securely provide access to stored account information and other personal information of the consumer (e.g. purchase fulfillment identifier IDs, log-in information, passwords, identification data, etc.). With the installation of a simple software client in the POS device 202, the POS device 202 can be programmed to operate with the purchase key 100 as described by method 300. Generally speaking, the POS device 202 can be programmed to retrieve credit or debit card information or other electronic wallet information from the purchase key 100 with no more effort than what is performed by credit card readers. The only differences are that the consumer needs to engage the purchase key 100 with the POS device 202 (which is effortless when using a wireless method) and perform a biometric authentication step to enable the POS device 202 to access to the memory 112 of the purchase key 100.

The purchase key 100 can be attractive to an end user from an ergonomic perspective, in that it can be a small item affixed to, for example, a keychain or a necklace which can provide a means to carry sensitive account information such as multiple credit or debit accounts, and other payment methods (e.g. Paypal™) that are conveniently stored, accessible, and secured in an event that the purchase key 100 is lost or stolen.

Method 300 can be applied in an on-line setting. For example, the purchase key 100 can be used for on-line transactions such as purchasing or for logging into a secure account. As an example, the user can use the purchase key 100 to conduct web-based transactions, such as the purchase of an item over the Internet from home or a business office. FIG. 5 illustrates a web page 500 that depicts the purchase key 100 as a payment option. A processing system 230 can offer a purchase key option in web page 500 as another payment option in addition to the traditional credit card payment methods. The processing system can be managed by a credit card system through a web server or by a client application operating on a local computer. If the user selects the purchase key option, a small ActiveX/Java object can be downloaded to a browser as an Applet that instructs the user to insert his/her purchase key 100 into a USB port of the computer 240 being used to access the web page 500. Once the purchase key 100 has been engaged with the computer 240, the user can perform a biometric authentication with a fingerprint reading as described before in method 300.

The applet can then present a new GUI similar to that of GUI 400 of FIG. 4 by way of the browser with a similar list of credit card credentials for the user to select from for completing the purchase. Once the user selects a purchase fulfillment ID, the ID can be sent securely to the processing system 230 (e.g. via HTTPS). For purposes of security, the applet can be signed and verified by a purchase key provider. Moreover the applet can be designed to not store or transmit any other contents of the purchase key 100 over the Internet. Since the retrieval of the purchase fulfillment ID from the purchase key 100 does not require the user to key in sensitive account information with a keypad of the computer 240, key-loggers or other spy-ware applications cannot readily sniff sensitive data exchanged with the processing system 230 to complete the purchase of a select good or service.

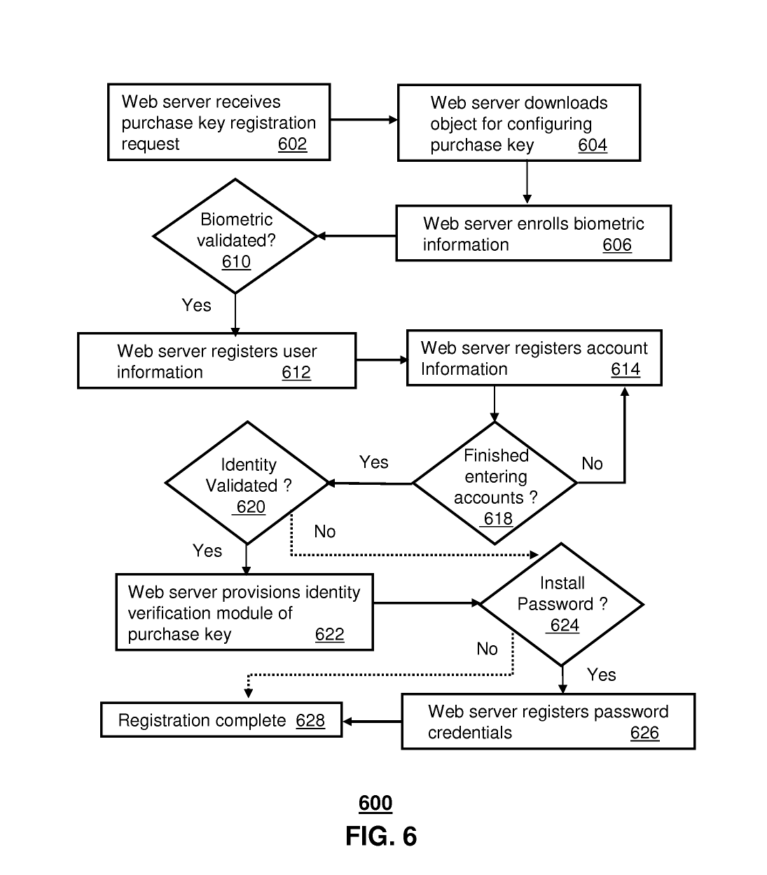

The processing system 230 can also be used to provision the purchase key 100 with a plurality of purchase fulfillment IDs through a web page that provides fingerprint enrollment, fingerprint validation, credit card registration, and user validation. FIG. 6 depicts a method 600 for provisioning the purchase key 100. The method 600 can start at step 602, where the processing system 230 receives a purchase key registration request from a computer 240 of an end user of the purchase key 100. This step can be the result of the end user buying a purchase key 100 from a purchase key provider, and later inserting the purchase key 100 into a USB port of the user's computer 240. The user can then access a web site hosted by the processing system 230 that provides enrollment of purchase fulfillment IDs (e.g. credit card numbers, driver's license number, passwords, financial account information, etc.). At step 604, the processing system 230 can download an object to the computer for provisioning the purchase key 100.

As an example, the object can be a verified and signed Applet for providing secure download of purchase fulfillment IDs to the purchase key 100. The computer 240 can run the secure applet to communicate the plurality of purchase fulfillment IDs entered by the user to the purchase key 100. At step 606, the processing system 230 can enroll biometric information, such as a finger print, captured from the biometric reader 110. At step 610, the processing system 230 can validate the biometric information. For example, upon capturing a finger print, the processing system 230 can validate an identity of the user from the fingerprint in combination with verification information provided by a back-end server (e.g. Idology™, Opinity™). The processing system 230 can also validate credentials of the user such as age, gender, name, and so forth from one or more back-end systems that provides access to on-line government documents or forms.

If the biometric authentication is successful, the processing system 230 can register the user's credentials, at step 612, which can include the biometric identifier, the name of the user, and any other descriptive information such as billing and shipping address. At step 614, the processing system 230 can request the user to enter the account information that the user wants to download to the purchase key 100. For example, the user can add account information for a credit card which can include a nickname for the credit card, a credit card number, expiration date, interest rate, balance, and security code. The user can continue to add account information for other credit or debit cards at decision step 618. Once the user has finished entering account information, the Applet can generate the corresponding purchase fulfillment IDs.

To provide an additional layer of security, at step 620, the processing system 230 can also provision the purchase key 100 with identity and age verification credentials to validate the user with the POS device 202 (and/or a validation back-end system coupled thereto) based on the biometric identifier and other credentials provided. For example, the processing system 230 can download another Applet that communicates with a common validation back-end system to provide validation of age and identity of the user from property records, department of motor vehicle records, state issued identification cards, immigration records, and/or vehicle registrations. Identity and age verification credentials can be installed in the identity verification module 130 of the purchase key 100 at step 622, when the identity of the user is validated in step 620 based on the biometric reading of step 606. If the identity of the user cannot be validated or the user does not desire this feature, the processing system 230 can proceed to step 624. Age and other common user credentials can be used as a form of authorized identification when using the purchase key 100 in situations where age limit requirements on certain commodities or services may be required. It should be noted that age and verification installation is a user option which is not required for using the purchase key 100.

At step 624, the processing system 230 can also install the password module 140 if requested by the user. This allows the user to use the purchase key 100 for managing log-in access, such as those requiring a password. More specifically, at step 626, the processing system 230 can download a secure Applet with one or more passwords and associated user names to the purchase key 100. Notably, the secure Applet is run on a local machine and thus does not communicate with the processing system 230 or any other transaction server, unless specifically allowed by the user. This ensures that password sensitive information is only received by the secure Applet and the purchase key 100. The Password module 140 of the purchase key 100 is then configured for providing password management to the user. It should be noted that password installation is also a user option which is not required for using the purchase key 100. At step 628, the registration and enrollment process is completed.

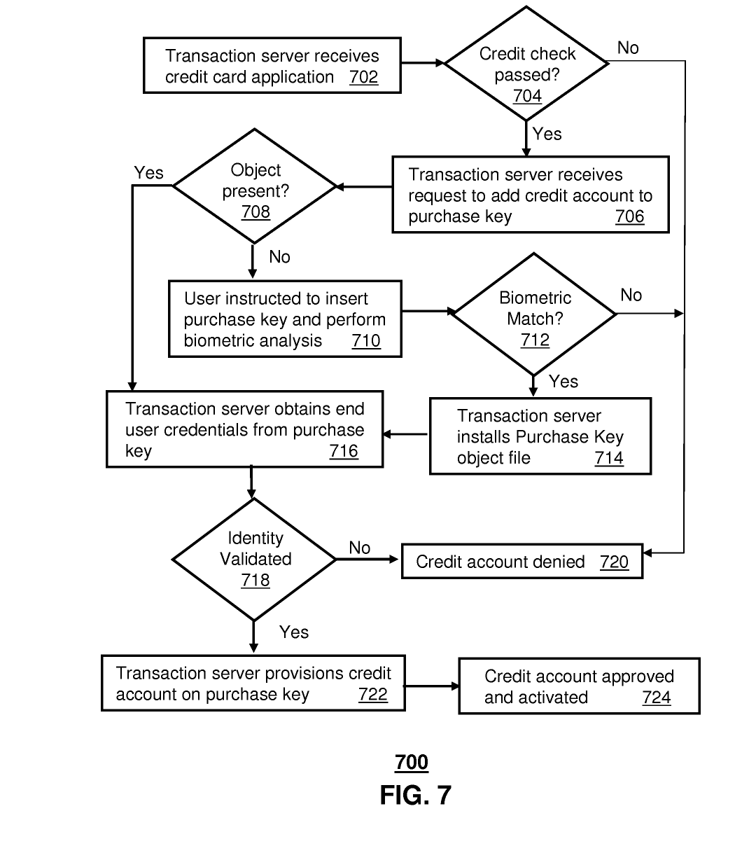

Referring to FIG. 7, an exemplary method 700 for issuing a credit account to a purchase key 100 through online signup process is presented. Briefly, the method 700 can be practiced with more or less than the number of steps shown and is not limited to the order of the steps shown. The method 700 can start at step 702, where a transaction server 250 receives credit application from a consumer. As one example, a user may sign up for a credit account while online using computer 240. The user can submit application credentials online, such as name, social security number, current accounts, and any other additional information, needed to conduct a credit check. If the credentials are not accepted the user can be denied a credit account at step 720.

If however, at step 704, the credentials are accepted and the credit check is passed, the user can be presented with a list of credit account options. As an example, the user can select to receive a credit card in the mail, or the user can elect to download the credit account information to a purchase key 100 for immediate use. In the latter option, at step 706, the transaction server 250 can receive a request to add a credit account to the purchase key 100. At step 708, the transaction server 250 can check whether a purchase key object file is in the computer 240 as a result of method 600. If the object file is not present, at step 710, the user can be instructed to insert the purchase key 100 to perform a biometric analysis as previously described with method 600.

At step 712, a biometric authorization can be performed, such as fingerprint matching. Upon biometric authorization, at step 714, the transaction server 250 can install a purchase key object file signed by the original purchase key provider. If the purchase key object file was present in step 708, or the transaction successfully installed the purchase key object file in step 714, the transaction server 250 can proceed to obtain credentials of the end user from the purchase key 100 at step 716. At step 718, the identity of the user can be validated by common validation means to authorized the issuance of the requested credit account. Steps 716-718 can be used to ensure that legitimate sign up information is used for opening the credit account. The credit issuer can verify the information read from the purchase key 100 with emerging identification providers (e.g. Idology™, Opinity™) for authorizing the credit account. If the identity check is invalid, the user is denied the credit account at step 720.

If the identity check is validated, the transaction server 250 can provision the purchase key 100 with new credit information at step 722. In practice, the purchase key object file provided by the transaction server 250, which may be an Applet or other secure program stored on the computer 240, can perform the provisioning of the purchase key 100. Upon successfully provisioning the credit card information (e.g. one or more purchase fulfillment IDs), at step 724, the transaction server 250 approves and activates the credit account.

From the foregoing descriptions, it would be evident to an artisan with ordinary skill in the art that the aforementioned embodiments can be modified, reduced, or enhanced without departing from the scope and spirit of the claims described below. For example, other services can be provided by a purchase key 100 such as tracking expenditures applied to each credit or debit account, querying a credit card provider while engaged with a POS device 202 for current balance and interest rate that would be charged for the current planned transaction. The purchase key 100 can query a credit card institution for information associated with a fulfillment ID. For example, the purchase key 110 can present current interest rates, loyalty points, bonus points, coupons, and account balance information for a particular fulfillment ID. Moreover, the purchase key 110 can recommend a fulfillment ID for conducting the transaction in view of the information. For instance, the purchase key 110 can compare the outstanding balances on each account, and in view of the interest rates, determine which fulfillment ID will incur the least interest payments after the transaction. As another example, a merchant or other party can impose a service fee for processing a transaction using the purchase key 100. From the embodiments of FIGS. 1-7 it should be evident to one of ordinary skill in the art that there are innumerable ways to use the purchase key 100. Accordingly, the reader is directed to the claims for a fuller understanding of the breadth and scope of the present disclosure.

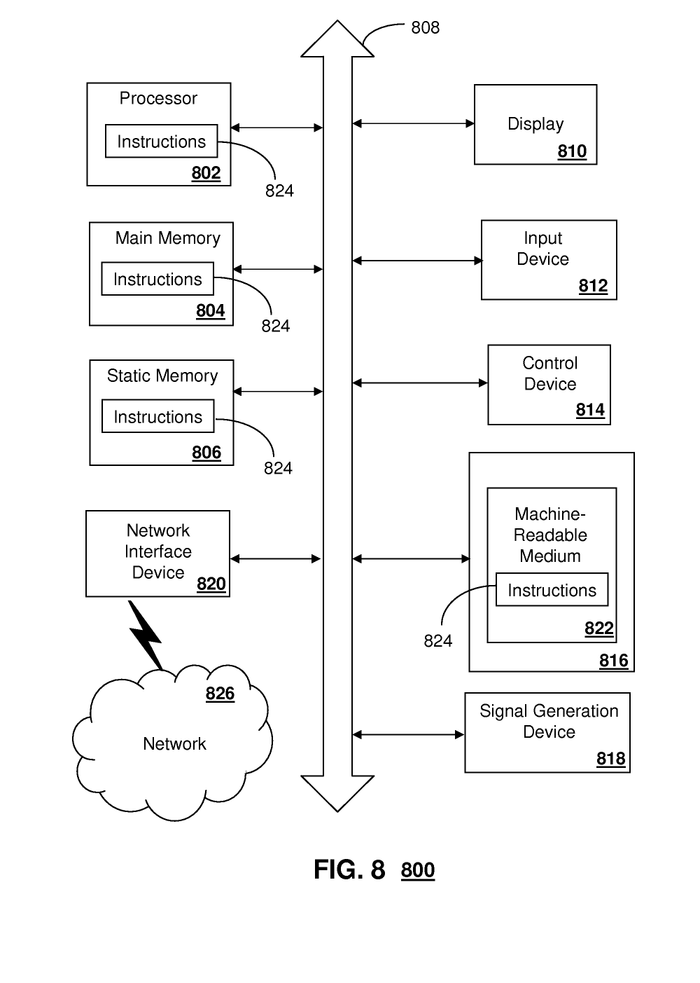

FIG. 8 depicts an exemplary diagrammatic representation of a machine in the form of a computer system 800 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 800 may include a processor 802 (e.g., a central processing unit (CPU), a graphics processing unit (GPU, or both), a main memory 804 and a static memory 806, which communicate with each other via a bus 808. The computer system 800 may further include a video display unit 810 (e.g., a liquid crystal display (LCD), a flat panel, a solid state display, or a cathode ray tube (CRT)). The computer system 800 may include an input device 812 (e.g., a keyboard), a cursor control device 814 (e.g., a mouse), a mass storage medium 816, a signal generation device 818 (e.g., a speaker or remote control) and a network interface device 820.

The mass storage medium 816 may include a computer-readable storage medium 822 on which is stored one or more sets of instructions (e.g., software 824) embodying any one or more of the methodologies or functions described herein, including those methods illustrated above. The computer-readable storage medium 822 can be an electromechanical medium such as a common disk drive, or a mass storage medium with no moving parts such as Flash or like non-volatile memories. The instructions 824 may also reside, completely or at least partially, within the main memory 804, the static memory 806, and/or within the processor 802 during execution thereof by the computer system 800. The main memory 804 and the processor 802 also may constitute computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 824, or that which receives and executes instructions 824 from a propagated signal so that a device connected to a network environment 826 can send or receive voice, video or data, and to communicate over the network 826 using the instructions 824. The instructions 824 may further be transmitted or received over a network 826 via the network interface device 820.

While the computer-readable storage medium 822 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a computer-readable storage medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A purchase fulfillment device, comprising:
a storage medium to store a plurality of purchase fulfillment identifiers (IDs) issued by a corresponding plurality of credit providers; and
a biometric reader to enable access to a point of sale (POS) device to retrieve at least one among the plurality of purchase fulfillment IDs in the storage medium.

2. The purchase fulfillment device of claim 1, comprising:
a Universal Serial Bus (USB) to electromechanically engage with the POS device for retrieving the at least one purchase fulfillment ID from the storage medium to consummate a purchase of a good or service; and
a housing assembly to house the USB, the storage medium and the biometric reader.

3. The purchase fulfillment device of claim 2, wherein the biometric reader comprises a fingerprint reader accessible by way of an exposed surface of the housing assembly, and wherein the storage medium comprises a flash memory.

4. The purchase fulfillment device of claim 1, wherein the storage medium is integrated in an identity module coupled to the biometric reader, and wherein the identity module and the biometric reader is housed in a housing assembly of the purchase fulfillment device.

5. The purchase fulfillment device of claim 1, comprising a communication interface to convey the at least one purchase fulfillment ID to the POS device.

6. The purchase fulfillment device of claim 1, wherein the biometric reader is at least one among a fingerprint reader, a retinal scanner, a palm reader, and a voice authentication system.

7. The purchase fulfillment device of claim 1, wherein the biometric reader comprises a fingerprint reader to selectively retrieve the at least one purchase fulfillment ID according to one or more fingerprint combinations of an end user of the purchase fulfillment device.

8. The purchase fulfillment device of claim 1, wherein the biometric reader enables access to the storage medium for retrieving the at least one purchase fulfillment ID responsive to a biometric authentication of an end user of the purchase fulfillment device.

9. The purchase fulfillment device of claim 1, wherein the plurality of purchase fulfillment IDs correspond to a plurality of payment option credentials, and wherein the purchase fulfillment device comprises a payment option module to manage the plurality of payment option credentials.

10. The purchase fulfillment device of claim 1, comprising an identity verification module to communicate with a back-end system to validate an end user of the purchase fulfillment device.

11. The purchase fulfillment device of claim 1, comprising a security module to engage in a secure communication with a web server or local device, and provision the purchase fulfillment device with credit card credentials provided by the web server or local device.

12. The purchase fulfillment device of claim 1, wherein the storage medium corresponds to a flash memory housed in at least one among a group of form factors comprising a micro Secure Device (microSD), a multi-media card (MMC), and a reduced size multi-media card (RS-MMC).

13. A point of sale (POS) device, comprising a controller element to receive from a purchase fulfillment device at least one among a plurality of purchase fulfillment IDs to process a transaction associated with a purchase of a good or service responsive to a biometric authentication validated by the purchase fulfillment device.

14. The POS device of claim 13, wherein the controller element provides connectivity to the purchase fulfillment device using at least one among a group of access technologies comprising Universal Serial Bus (USB), Bluetooth, Radio Frequency Identification (RFID), and Wireless Fidelity (WiFi).

15. The POS device of claim 13, wherein the controller element presents a graphical user interface and receives a directive to select the at least one purchase fulfillment ID for processing the transaction.

16. The POS device of claim 13, wherein the controller element supplies to a transaction server the at least one purchase fulfillment ID to approve the purchase of the good or service.

17. The POS device of claim 13, wherein the controller element securely receives the at least one purchase fulfillment ID from the purchase fulfillment device.

18. A transaction server, comprising a controller element to receive at least one among a plurality of purchase fulfillment IDs retrieved by a point of sale (POS) device from a memory of a purchase fulfillment device in response to a biometric authorization validated by the purchase fulfillment device.

19. The transaction server of claim 18, wherein the controller element approves a purchase of a good or service with the at least one purchase fulfillment ID, and records a cost of the purchase.

20. The transaction server of claim 19, wherein the controller element:
charges an end user of the purchase fulfillment device a service fee for approving the purchase; and
submits to the end user a bill comprising the cost of the purchase, and the service fee.

21. The transaction server of claim 18, wherein the controller element issues to a consumer a credit account for purchasing goods or services, and provisions a purchase fulfillment device with credit information associated with the credit account.

22. The transaction server of claim 21, wherein the controller element issues the credit account responsive to performing a successful credit check on said consumer.

23. A processing system comprising a controller element to provision a storage medium of a purchase fulfillment device with a plurality of purchase fulfillment IDs, wherein access to the plurality of purchase fulfillment IDs stored in the storage medium is secured by a biometric reader.

24. The processing system of claim 23, wherein the controller presents a graphical user interface (GUI) in the form of a web page that provides a means to perform at least one among a biometric enrollment and validation of the biometric reader, a registration of the plurality of purchase fulfillment IDs, and a user validation.

25. The processing system of claim 23, wherein the biometric reader corresponds to a fingerprint reader, and wherein each purchase fulfillment ID corresponds to at least one among credit card information, and debit card information.

26. The processing system of claim 25, wherein the controller element provisions the purchase fulfillment device with the plurality of purchase fulfillment IDs responsive to enrolling and validating the biometric reader.

27. The processing system of claim 26, wherein the controller element charges an end user of the purchase fulfillment device a service fee for provisioning the purchase fulfillment device.

28. The processing system of claim 23, wherein the controller element provisions the purchase fulfillment device with at least one among a credit card module and a password module.

29. The processing system of claim 28, wherein the credit card module manages at least a portion of the purchase fulfillment IDs, and wherein the password module manages login information for accessing secure accounts.

30. The processing system of claim 23, wherein the controller element provisions a computer coupled to the purchase fulfillment device to securely configure the purchase fulfillment device.

31. The processing system of claim 23, wherein the controller element is managed by a credit card system or a client application operating on a local computer.

32. The processing system of claim 23, wherein the controller element queries a credit card system to obtain information related to a fulfillment ID for a desired transaction, and presents to the user the information associated with fulfillment ID.

33. The processing system of claim 32, wherein the information identifies at least one among a current interest rate, loyalty points, bonus points, coupons, and account balance information

34. The processing system of claim 32, wherein the controller element recommends a fulfillment ID for conducting the transaction in view of the information.
